(19) United States
(12) Patent Application Publication
(10) Pub. No.: US 2004/0261285 A1
(43) Pub. Date: Dec. 30, 2004

(54) Drying machine system utilizing gas turbine, and method of use

(76) Inventor: Kenichi Harada, Kyoto (JP)

Correspondence Address: BAKER & DANIELS, 111 E. WAYNE STREET, SUITE 800, FORT WAYNE, IN, 46802

(21) Appl. No.: 10/496,526

(22) PCT Filed: Oct. 15, 2002
(86) PCT No.: PCT/JP02/10692

(30) Foreign Application Priority Data
Nov. 22, 2001 (JP) 2001358162

(51) Int. Cl. F26B 3/00

(52) U.S. Cl. 34/514

(57) ABSTRACT

A drying machine system utilizing a gas turbine, comprising a gas turbine, a power generator operated thereby, and a waste heat recovering means for recovering heat from exhaust gases from the gas turbine and feeding it to a drying machine, characterized in that the gas turbine is composed of a plurality of unlubricated type micro-gas turbines and the waste heat recovering means is composed of a waste gas feed passageway for feeding waste gases from the gas turbine directly to the drying machine; and a method of use of a drying machine system utilizing the gas turbine. An efficient facility and an efficient method of use are provided wherein the gas turbine is in the form of a plurality of small-sized micro-gas turbines and the turbine shaft bearings are of the type dispensing with lubricating oil, resulting in clean exhaust gases, whereby high temperature exhaust gases can be reused with high efficiency.

### TECHNICAL FIELD

The present invention relates to a drying machine system utilizing a gas turbine which generates electric power by a gas turbine and utilizes an exhaust gas thereof for a drying machine, and a method of using the same, and more particularly to a technique for achieving an efficient drying machine system which generates electric power and utilizes exhaust heat by using a comparatively compact gas turbine, and a method of using the same.

### BACKGROUND ART

A generating equipment by the gas turbine is frequently used in a building, an eating and driving place and the like in an area which is unsavory in an electric power supply state, or as a main portion of a co-generation infrastructure (system). FIG. 6 shows a principle structure of the drying machine system utilizing the gas turbine having the gas turbine generating equipment.

In other words, a drying machine system A utilizing a gas turbine is constituted by a turbine shaft 103 in which a turbine 101 is provided in one end and a compressor 102 is provided in another end, a power generator 105 which is operated to generate power on the basis of a rotation of an output shaft 104 in the compressor 102, a combustor 106 which executes a combustion by using a high pressure air supplied from the compressor 102, a regenerator 107, a waste heat recovering equipment 108, an inverter (a rectifier) 109 and the like.

The air sucked via a filter 110 is compressed to a high pressure by the compressor 102, a large amount of compressed air is blown into the combustor 106 so as to be burned, the turbine 101 is rotated at a high speed by the high temperature gas flow so as to rotate the compressor 102 and the power generator 105, and the electricity generated by the power generator 105 is taken out as a generated power output via the inverter 109. The heat of the high temperature exhaust gas output through the turbine 101 is exchanged with the intake air by the regenerator 107, and the heat recovered by the waste heat recovering equipment 108 is reused as a heat source of the drying machine or the like.

As mentioned above, in the drying machine system utilizing the gas turbine, the efficient system is achieved by effectively utilizing the exhaust gas after the power generation. Accordingly, attention has been paid to a high-efficiency drying machine system utilizing a gas turbine which utilizes the exhaust heat from the gas turbine generating equipment for a heating machine such as a drying machine of a manufacturing plant or the like, while using a liquid natural gas (LNG) as a fuel.

In the case that the drying machine system mentioned above is provided, the LNG corresponding to the fuel for combustion and the electricity corresponding to the drive source of each of electrical devices are required for activating a whole of the manufacturing plant. Accordingly, a total amount of energy required as a whole is reduced by arranging a comparatively large-sized gas turbine generating equipment, and a heat exchanger such as a waste heat recovering equipment capable of recovering the exhaust gas as the heat.

However, since the gas turbine as mentioned above has a large size, a lubricating oil is required for a bearing for bearing a turbine shaft, so that the lubricating oil is mixed into the exhaust gas. Since it is a reason for mixing foreign matters into a product to directly introduce the exhaust gas to which the lubricating oil is mixed, the system utilizes the exhaust gas as an auxiliary heat source of the drying machine after recovering the exhaust gas as the heat. However, in this case, the energy of the exhaust gas is not sufficiently made good use.

Further, in the case that the drying machine is activated by one large-sized gas turbine generating equipment, if the gas turbine breaks down, the drying machine system utilizing the gas turbine can not be used for a long time until a repair of the gas turbine is finished.

An object of the present invention is to provide a drying machine system utilizing a gas turbine and a method of using the same in a more excellent efficiency state.

### SUMMARY OF THE INVENTION

In accordance with the present invention, there is provided a drying machine system utilizing a gas turbine comprising:

a gas turbine;

a generating equipment operated by the gas turbine; and

a waste heat recovering means for recovering a heat from an exhaust gas of the gas turbine so as to supply to the drying machine,

wherein the gas turbine is constituted by a plurality of unlubricated type micro-gas turbines, and the waste heat recovering means is constituted by an exhaust gas supply path for directly supplying the exhaust gas from the gas turbine to the drying machine.

In accordance with another aspect of the present invention, there is provided a method of using the drying machine system utilizing the gas turbine.

### DETAILED DISCLOSURE OF THE INVENTION

A drying machine system utilizing a gas turbine in accordance with the present invention has a gas turbine, a generating equipment operated by the gas turbine, and a waste heat recovering means for recovering a heat from an exhaust gas of the gas turbine so as to supply to the drying machine. Further, the gas turbine is constituted by a plurality of unlubricated type micro-gas turbines, and the waste heat recovering means is constituted by an exhaust gas supply path for directly supplying the exhaust gas from the gas turbine to the drying machine. Since the gas turbine is structured by preparing a plurality of small-sized micro-gas turbines, an air bearing requiring no lubricating oil can be set as a bearing of a turbine shaft, and it is possible to prevent the lubricating oil for the bearing from being mixed into a high temperature exhaust gas output through the turbine. Accordingly, it is possible to make the exhaust gas clean. Therefore, it is possible to use the high temperature exhaust gas of the gas turbine as the heat source of the drying machine as it is, and it is unnecessary to pass the high temperature exhaust gas through the heat exchanger, so that an energy loss is reduced at that degree, and an efficiency of the system is improved.

Further, even in the case that an output of one gas turbine is small, a total output can be set to a predetermined value by forming the generating equipment by a plurality of micro-gas turbines. Further, even in the case that, for example, one micro-gas turbine breaks down, the other micro-gas turbines are in an operating state, so that it is possible to sufficiently supply the exhaust gas from the other micro-gas turbines, and the drying machine system utilizing the gas turbine can continue the operation. Further, even in the case that a capacity of the drying machine is fluctuated, it is possible to control the system on the basis of the number of the operating micro-gas turbines.

Accordingly, since it is possible to supply the exhaust gas of the gas turbine as it is to the drying machine and it is unnecessary to arrange the heat exchanger taking out the heat from the exhaust gas as is different from the conventional one, the energy loss is reduced at that degree, the efficiency of the system is improved, and it is possible to keep activating the drying machine even in the case that some disadvantages such as failure or the like are generated.

In preferable, in the structure of the system mentioned above, the exhaust gas supply path feeds the exhaust gas to a combustion chamber of the drying machine, and is provided with a power supplying means for supplying an electricity generated in the generating equipment to the electric devices of the drying machine.

In accordance with the structure, an efficient drying effect can be obtained by directly supplying the exhaust heat from the exhaust gas to the combustion chamber of the drying machine, and the electricity generated by the generating equipment can be used for the electric devices of the drying machine. Accordingly, it is possible to self-supplement the energy as the system, it is possible to self-complete the energy in some cases, and the like, whereby it is possible to construct an efficient drying machine system utilizing a gas turbine.

More preferably, in the structure of the system mentioned above, there are provided a first pressure control means for controlling a pressure by an entire exhaust gas from a plurality of micro-gas turbines to a predetermined value, and a second pressure control means for controlling a gas pressure within the drying machine by the exhaust gas supplied to the drying machine to a predetermined value.

In accordance with the structure mentioned above, since it is possible to control the pressure of the entire exhaust gas on the basis of the operation of a plurality of micro-gas turbines to the predetermined pressure, by the first pressure control means, it is possible to control the gas turbines in an efficient operation state as a whole, and it is possible to execute the gas pressure control as a whole by controlling the gas pressure to a gas pressure required for a single drying machine or a plurality of drying machines. Further, since it is possible to control the pressure of the exhaust gas supplied to the drying machine to a gas pressure actually required in the drying machine by the second pressure control means, it is possible to execute control such as effectively operating the drying machine and achieving a drying effect with an improved heat efficiency. In other words, it is possible to obtain an improved operation state of each of the gas turbine and the drying machine, by two kinds of gas pressure controls.

Further, in the case that a plurality of drying machines exist, there can be considered a matter that the pressure within each of the drying machines generates hunting in accordance with the general pressure control, and a differential pressure with respect to the ambient air is increased, however, since the second pressure control means controls the gas pressure within the drying machine to the predetermined value, it is possible to execute a high-precision pressure control in the drying machine.

In particularly preferable, the first pressure control means is structured such as to execute a feed-forward control of an output of a part of a plurality of micro-gas turbines in correspondence to a set gas pressure of a main path through which an entire exhaust gas passes, in the exhaust gas supply path, and the second pressure control means is structured such as to adjust an opening degree of a bypass valve provided in the exhaust gas supply path on the basis of a detected information by a pressure detecting means provided in the drying machine.

In accordance with the structure mentioned above, by controlling the output of a part of the micro-gas turbines, the remaining micro-gas turbines execute the feed-forward control while performing a steady operation and maintaining an operation state having an improved heat efficiency. Accordingly, it is possible to provide a control equipment in which a structure is comparatively simple and a cost is small. Further, it is possible to avoid an uncontrollability due to the hunting mentioned above by controlling the pressure within the drying machine to the predetermined value on the basis of an adjustment of an opening degree of the bypass valve, and it is possible to secure a necessary amount of heat for the drying machine at pleasure, so that it is possible to execute a more detailed pressure control such as reducing an introduction amount of the combustion air as much as possible, or the like.

Further, this drying machine is provided with a combustion equipment to which the fuel for the micro-gas turbine is supplied. Accordingly, the combustion equipment can be conveniently used as an auxiliary heat source at a time when a capacity falls short only by the exhaust gas of the gas turbine, and can be conveniently used as a heat source in the case that the exhaust gas can not be used due to the failure, an inspection and maintenance and the like. Further, since the combustion equipment uses the fuel for the gas turbine, the common fuel with the gas turbine can be used, and a fuel supply system can be constituted by a single system. It is possible to intend to simplify the structure and achieve a cost reduction, in comparison with the case that the separate fuels and the separate supply systems are provided.

A method of using a drying machine system according to the present invention is characterized in that, in accordance with a method of using a drying machine system utilizing a gas turbine of executing a power generation by a gas turbine and recovering a heat from an exhaust gas of the gas turbine so as to supply to a drying machine, the gas turbine is constituted by a plurality of unlubricated type micro-gas turbines, and tie exhaust gas from a plurality of micro-gas turbines is directly supplied to the drying machine. This corresponds to a method of the drying machine system mentioned above, and it is possible to obtain the same effect as the effect obtained by the drying machine system.

### BRIEF DESCRIPTION OF THE DRAWINGS

FIG. 1 is a system view showing a schematic structure of a drying machine system utilizing a gas turbine.

FIG. 2 is a cross sectional view showing a schematic structure of the drying machine.

FIG. 3 is a schematic system view showing a generating equipment constituted by a micro-gas turbine.

FIG. 4 is a schematic view of a drying machine system utilizing a gas turbine in accordance with a comparative embodiment.

FIG. 5 is a block diagram showing a control equipment and a control circuit thereof.

FIG. 6 is a system view showing a schematic structure of a drying machine system utilizing a gas turbine having a gas turbine generating equipment in accordance with a conventional art.

### EMBODIMENT

A description will be given of an embodiment in accordance with the present invention with reference to the accompanying drawings.

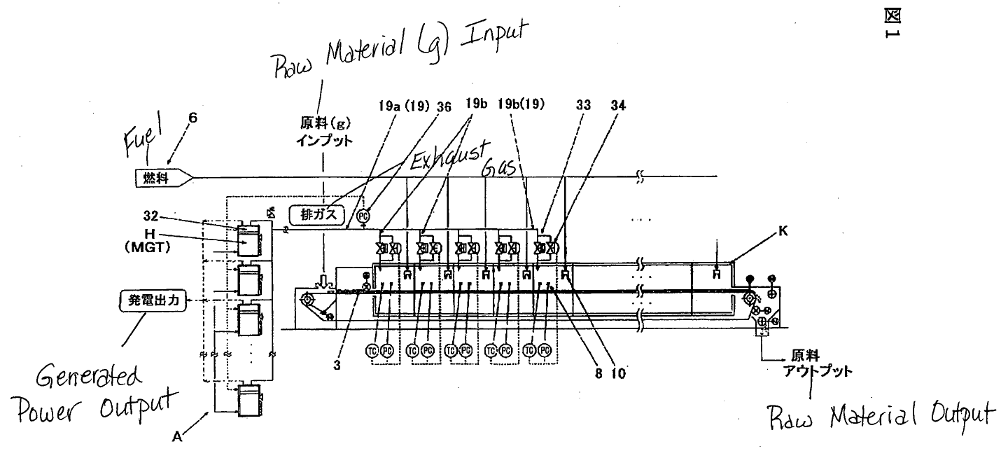

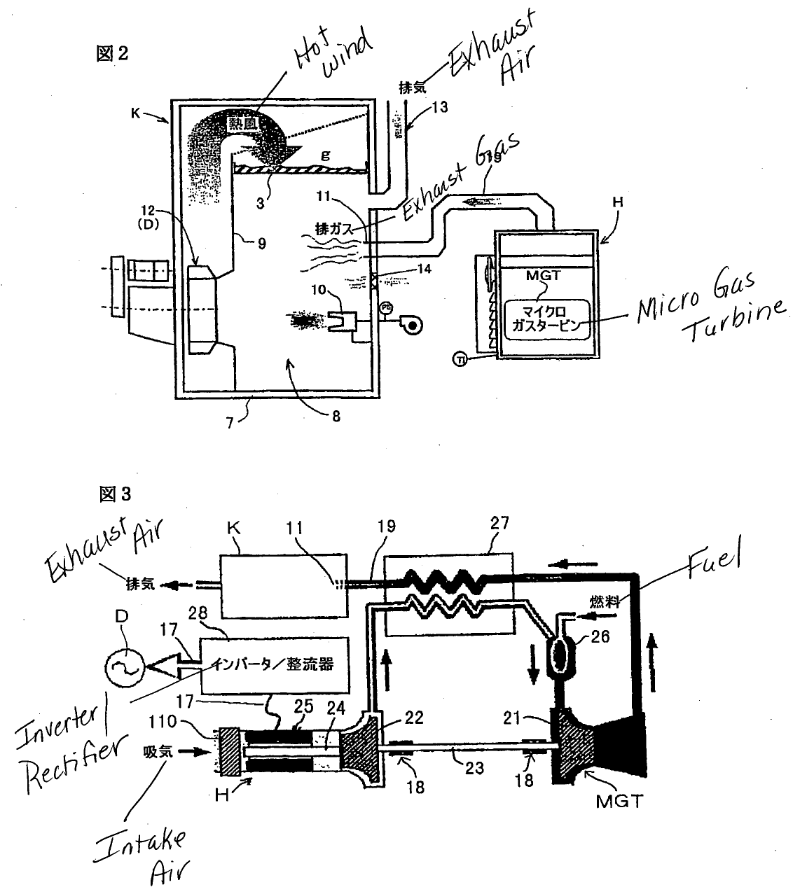

FIG. 1 shows a schematic view of one of gas turbine co-generation systems structured such that a power generation and an exhaust gas utilization in a drying machine K are executed by using a plurality of micro-gas turbine generating equipmentes H, that is, a drying machine system utilizing a gas turbine (hereinafter, called as a gas drying machine system for short) A, and FIG. 2 shows a principle structure of the drying machine K, respectively.

The gas drying machine system A is constituted by a belt conveyor 3 which feeds a supplied raw material g in a horizontal direction, a drying machine K which dries the raw material g fed by the belt conveyor 3, a plurality of micro-gas turbine generating equipmentes H, a supplying means 6 of a fuel such as the LNG, a liquid petroleum gas (LPG) or the like, and the like.

As shown in FIG. 2, the drying machine K is constituted by a box-shaped frame body 7, a combustion chamber 8 which is formed in an inner portion of the flame body in a state in which the belt conveyor 3 is passed through an upper portion, a burner 10 and a leading end portion 11 of an exhaust gas supply pipe (one example of an exhaust gas supply path, and one example of a waste heat recovering means hk) 19 which are arranged in the combustion chamber 8, an electric motor utilizing circulating fan 12 (one of electric devices D) for supplying a combustion heat of the burner 10 and a heat of an exhaust gas from the exhaust gas supply pipe 19 to the raw material g mounted on the belt conveyor 3 from an upper side thereof, a guide wall 9, an exhaust pipe 13 and the like. In this case, the drying machine K may serve as an intake means and may appropriately suck the ambient air (a fresh air) into the combustion chamber from an intake port 14.

In other words, the raw material g is dried by spraying the combustion heat of the burner 10 and the exhaust heat of the high temperature exhaust gas from a micro-gas turbine MGT to the raw material g on the belt conveyor 3 by the circulating fan 12.

As shown in FIG. 3, the micro-gas turbine generating equipment H is basically the same as that shown in FIG. 6 mentioned above, except the structure that the gas turbine is constituted by a plurality of unlubricated type small-sized gas turbines, that is, micro-gas turbines MGT. In other words, the micro-gas turbine generating equipment H is constituted by a turbine shaft 23 in which a turbine 21 is provided in one end and a compressor 22 is provided in another end, a power generator 25 which is operated to generate power on the basis of a rotation of an output shaft 24 in the compressor 22, a combustor 26 which executes a combustion by using a high pressure air supplied from the compressor 22, a regenerator 27 which preheats the high pressure air to the combustor 26 by the heat of the exhaust gas, and an inverter 28. A waste heat recovering equipment (the structure shown by reference numeral 108 in FIG. 6) in this case is a drying machine K.

In other words, in the micro-gas turbine MGT having a small output, an air bearing (which is known and is not illustrated) 18 can be employed as a bearing for bearing the turbine shaft 23 rotating at a high speed. Accordingly, it is not necessary to supply the lubricating oil to the bearing as is different from the large-sized gas turbine. Therefore, the lubricating oil for the bearing is not mixed into the exhaust gas of the micro-gas turbine MGT, and it is possible to take out a clean exhaust gas. Accordingly, it is possible to directly supply the exhaust gas to the drying machine K.

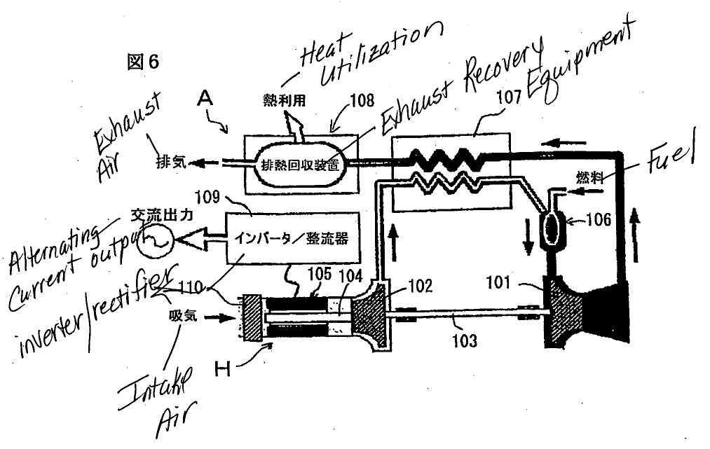

Next, a description will be given of a control equipment. As shown in FIGS. 1 and 5, the control equipment in accordance with the present invention is provided with a pressure control means 29 constituted by a first pressure control means 30 for controlling a pressure of an entire exhaust gas from a plurality of micro-gas turbines MGT to a predetermined value, and a second pressure control means 31 for controlling a gas pressure within the drying machine K generated by the exhaust gas introduced into the drying machine K to a predetermined value.

The first pressure control means 30 is structured such as to feed-forward control the output of a part of a plurality of micro-gas turbines in correspondence to a set gas pressure of a main conduit pipe (an example of a main path in the exhaust gas supply path through which an entire exhaust gas passes) 19a in the exhaust supply pipe 19. In more detail, it is structured such as to be provided with a first pressure setting means 35 which can operate to increase and reduce a combustion outputting means 32 equipped in each of the micro-gas turbine generating equipment H independently or all together. In this case, the structure may be made such as to be provided with a first pressure detecting means 36 for detecting a gas pressure of the main conduit pipe 19a, and execute a feedback control of adjusting to increase and reduce an output of the micro-gas turbine MGT on the basis of a detected information.

The second pressure control means 31 is structured such as to adjust an opening degree of a bypass valve 34 which is provided in parallel to a duct valve 33 in the exhaust gas supply pipe 19, in detail, a branch passage 19b prepared in each of the drying machines K, on the basis of a detected information obtained by a pressure detecting means PC equipped in the drying machine K. Further, the structure may be made such as to be provided with a temperature control means 37 for executing an opening degree of the burner 10, that is, a combustion temperature, on the basis of a detected information of a temperature detecting means TC provided in the combustion chamber 8 in each of the drying machines K.

As mentioned above, since the control equipment mainly with respect to the pressure is provided, the following advantages (1) to (4) are obtained. (1): It is possible to control a supply amount of a high temperature exhaust gas to the drying machine K every combustion chambers 8 such that the temperature and the pressure of the combustion chamber 8 in the drying machine K satisfy a predetermined condition, owing to the pressure control means 29. (2): In the general pressure control, there is a fear that the pressure in each of the combustion chambers 8 of the drying machines K generates hunting, and the differential pressure with respect to the ambient air tends to be larger than a set value, however, in the present invention, since the pipe and the control valve which are in conformity with a control wind amount determined by calculation are placed as the bypass valve 34, in addition to the pipe and the valve (the duct valve 33) for a quantitative blowing, it is possible to execute a high-precision control, and it is possible to avoid the fear mentioned above. (3) Since the structure is made such that the output side pressure serving as the gas turbine is fixed by feed-forward controlling the output of a part of a plurality of micro-gas turbines MGT, it is possible to prevent the control valve in each of the combustion chambers 8 from being interfered with each other so as to be out of control, and the control is executed such that a heat efficiency does not drop down as a whole, by carrying out a steady operation of the remaining micro-gas turbines MGT. (4) It is possible to null the fresh air supplied to the combustion chamber 8 to the maximum, by the pressure control means 29, and the heat efficiency of the drying machine K is substantially improved.

An operation in outline of the entire of the gas drying machine system A is as follows. In other words, the structure is made such that the fuel such as the LNG or the like is supplied to the burner 10 corresponding to the main combustion equipment in the micro-gas turbine generating equipment H and the drying machine K, and the electricity generated in the micro-gas turbine generating equipment H is supplied to each of the electric devices D via a wire (an example of the power feeding means) 17. A short electricity is supplied from an external power source (not shown). Accordingly, a required total energy amount by the fuel and the electricity can be reduced, and a cost can be reduced.

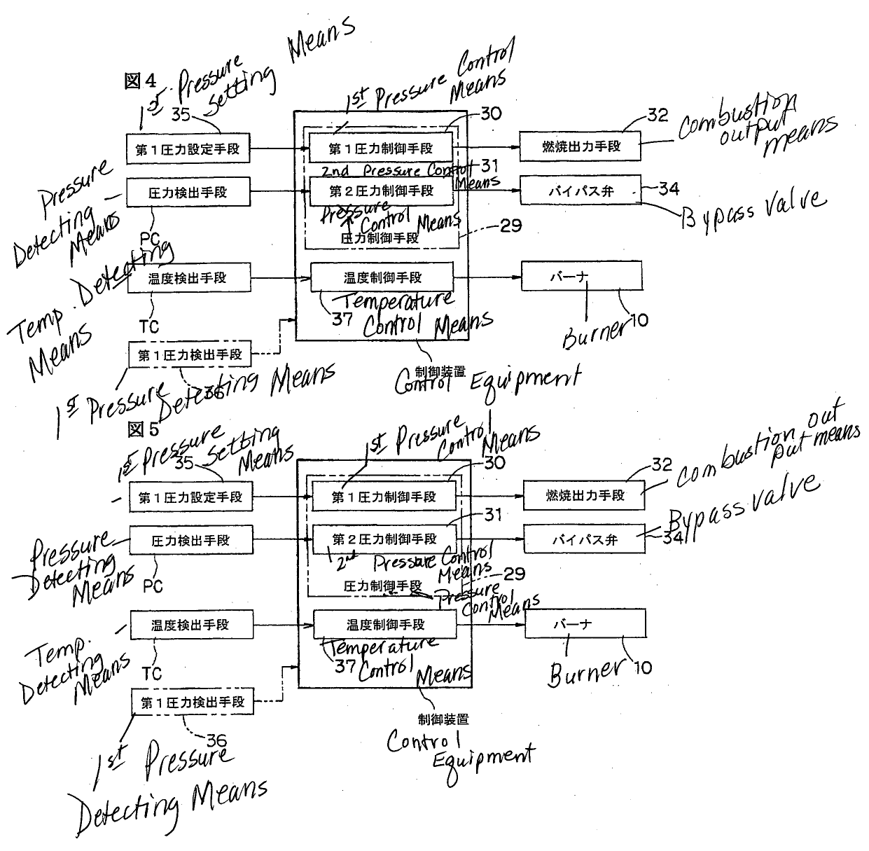

For example, in the case of a system using a large-sized oil feeding type gas turbine, as in a gas drying machine system in accordance with a comparative embodiment shown in FIG. 4, since the bearing of the turbine shaft requires a lubricating oil, the lubricating oil is mixed into the exhaust gas. Accordingly, since the structure is made such that the fresh air is heated by using the heat exchanger from the high temperature exhaust gas, and the heated fresh air is supplied to the drying machine, the heat efficiency is reduced due to the existence of the heat exchanger, and an energy loss is generated.

Therefore, in the gas drying machine system A in accordance with the present invention provided with a plurality of micro-gas turbine generating equipmentes H, since it is possible to directly introduce the exhaust gas to the combustion chamber 8 of the drying machine K, no heat exchanger is required, and it is possible to achieve a higher-efficiency drying machine system utilizing a gas turbine on the basis of the reduction of the energy loss.

Further, since the gas turbine has a small size, it is possible to operate and stop the gas turbine generating equipment easily and for a short time. Further, since a plurality of power generators 25 are placed, an adverse effect to the power source and the fuel supply side due to the trouble in the devices can be reduced, and there is an advantage that a stable operation can be performed. In this case, the drying machine K may constituted by one drying machine or a plurality of drying machines.

Industrial Applicability

As mentioned above, in the drying machine system utilizing the gas turbine, and the using method thereof in accordance with the present invention, the gas turbine is constituted by a plurality of small-sized micro-gas turbines, the bearing of the turbine shaft is set to the type requiring no lubricating oil, and the clean exhaust gas can be achieved. Accordingly, it is possible to provide the high-efficiency plant which has an improved efficiency of the high temperature exhaust gas and can reuse the exhaust gas, or the high-efficiency using method.

In particular, the present invention is preferable for the drying machine plant or the like which requires a large amount of heat amount. Further, there is an advantage that a self-completion of an energy can be achieved as the system using the generated electricity and the gas turbine fuel for the drying machine, and it is possible to achieve the drying machine system utilizing the gas turbine and the using method thereof having a better efficiency. Further, in the case that the pressure control equipment is provided, there is an advantage that the drying machine system utilizing the gas turbine having the better efficiency can be achieved as a structure which is excellent in reliability.

Description of Reference Numerals

8 combustion chamber

10 burner

17 electric power feeding means

19 exhaust gas supply path

19a exhaust gas supply path (main path)

30 first pressure control means

31 second pressure control means

33 duct valve

34 bypass valve

hk waste heat recovering means

D electric device

H generating equipment

K drying machine

MGT micro-gas turbine

PC pressure detecting means

What is claimed is:

1. A drying machine system utilizing a gas turbine comprising: a gas turbine;
a generating equipment operated by the gas turbine; and
a waste heat recovering means for recovering a heat from an exhaust gas of said gas turbine so as to supply to the drying machine,
wherein said gas turbine is constituted by a plurality of unlubricated type micro-gas turbines, and said waste heat recovering means is constituted by an exhaust gas supply path for directly supplying the exhaust gas from said gas turbine to said drying machine.

2. The drying machine system utilizing a gas turbine according to claim 1, wherein said exhaust gas supply path feeds said exhaust gas to a combustion chamber of said drying machine, and is provided with a power supplying means for supplying an electricity generated in said generating equipment to the electric devices of said drying machine.

3. The drying machine system utilizing a gas turbine according to claim 1, wherein the drying machine system utilizing the gas turbine is provided with a first pressure control means for controlling a pressure by an entire exhaust gas from a plurality of said micro-gas turbines to a predetermined value, and a second pressure control means for controlling a gas pressure within said drying machine by the exhaust gas supplied to said drying machine to a predetermined value.

4. The drying machine system utilizing a gas turbine according to claim 2, wherein the drying machine system utilizing the gas turbine is provided with a first pressure control means for controlling a pressure by an entire exhaust gas from a plurality of said micro-gas turbines to a predetermined value, and a second pressure control means for controlling a gas pressure within said drying machine by the exhaust gas supplied to said drying machine to a predetermined value.

5. The drying machine system utilizing a gas turbine according to claim 4, wherein said first pressure control means is structured such as to execute a feed-forward control of an output of a part of a plurality of micro-gas turbines in correspondence to a set gas pressure of a main path through which said entire exhaust gas passes, in said exhaust gas supply path, and said second pressure control means is structured such as to adjust an opening degree of a bypass valve provided in said exhaust gas supply path on the basis of a detected information by a pressure detecting means provided in said drying machine.

6. The drying machine system utilizing a gas turbine according to claim 1, wherein said drying machine is provided with a combustion equipment to which the fuel for said micro-gas turbine is supplied.

7. The drying machine system utilizing a gas turbine according to claim 5, wherein said drying machine is provided with a combustion equipment to which the fuel for said micro-gas turbine is supplied.

8. A method of using a drying machine system utilizing a gas turbine of executing a power generation by a gas turbine and recovering a heat from an exhaust gas of the gas turbine so as to supply to a drying machine, wherein said gas turbine is constituted by a plurality of unlubricated type micro-gas turbines, and the exhaust gas from a plurality of micro-gas turbines is directly supplied to said drying machine.
